(19) United States
(12) Patent Application Publication
(10) Pub. No.: US 2026/0188633 A1
(43) Pub. Date: Jul. 2, 2026

(54) PHOTOMULTIPLIER TUBE

(71) Applicant: HAMAMATSU PHOTONICS K.K., Hamamatsu-shi, Shizuoka (JP)

(72) Inventors: Yuki NISHIMURA, Hamamatsu-shi, Shizuoka (JP); Narumi MATSUDA, Hamamatsu-shi, Shizuoka (JP); Sho HIKOSAKA, Hamamatsu-shi, Shizuoka (JP); Kota KATSUYAMA, Hamamatsu-shi, Shizuoka (JP)

(73) Assignee: HAMAMATSU PHOTONICS K.K., Hamamatsu-shi, Shizuoka (JP)

(21) Appl. No.: 18/857,942

(22) PCT Filed: Dec. 26, 2022
(86) PCT No.: PCT/JP2022/048007

§ 371 Date: Oct. 18, 2024

(30) Foreign Application Priority Data
Apr. 27, 2022 (JP) 2022-073485

(51) Int. Cl. H01J 43/16

(52) U.S. Cl. CPC H01J 43/16

(57) ABSTRACT

Provided is a photomultiplier tube including: a photoelectric surface configured to emit photoelectrons in response to incident light; an electron multiplying unit including a plurality of dynodes configured to emit secondary electrons in response to incidence of the photoelectrons emitted from the photoelectric surface and to multiply the secondary electrons; an acceleration electrode disposed between the photoelectric surface and the electron multiplying unit and configured to accelerate the photoelectrons to be incident to the electron multiplying unit; and a tubular accommodation container accommodating the photoelectric surface, the acceleration electrode, and the electron multiplying unit.

### TECHNICAL FIELD

The present disclosure relates to a photomultiplier tube.

### BACKGROUND ART

Patent Literature 1 discloses a photomultiplier tube. The photomultiplier tube includes a photocathode that emits photoelectrons, a dynode unit including a plurality of stages of dynodes which emit secondary electrons in response to incidence of the photoelectrons from the photocathode, and multiplies the secondary electrons, a focusing electrode that is disposed between the photocathode and the dynode unit and has a through-hole through which the photoelectrons from the photocathode pass, and an acceleration electrode that is disposed between the focusing electrode and the dynode unit and accelerates the photoelectrons arrived from the photocathode through the focusing electrode.

### CITATION LIST

### Patent Literature

Patent Literature 1: Japanese Unexamined Patent Publication No. 2008-535147

### SUMMARY OF INVENTION

### Technical Problem

In the photomultiplier tube described in Patent Literature 1, a first stage of dynode and a second stage of dynode are set to directly face the acceleration electrode without any conductive member interposed therebetween, thereby reducing a variation in electron transit time.

By the way, in the technical field, further speed-up is desired to improve time resolution. One of indicators of speed-up is to reduce transit time spread (TTS). TTS is transit time fluctuation of a pulse of a single photoelectron when the entire of a photoelectric surface is irradiated with a single photon. According to finding of the present inventors, it is possible to reduce TTS to a certain extent by the photomultiplier tube described in Patent Literature 1. On the other hand, according to the finding of the invention, it is necessary to apply an extremely high voltage in order to further reduce the TTS in the photomultiplier tube described in Patent Literature 1. This is because a focal length is increased in correspondence with interposition of the focusing electrode between the photocathode and the acceleration electrode, an electric field intensity of the acceleration electrode decreases, and as a result, it is necessary to apply a high voltage to the acceleration electrode in order to compensate the decrease in the electric field intensity. In addition, when the voltage is increased, a problem of withstand voltage failure may be apparent.

Here, an object of the present disclosure is to provide a photomultiplier tube capable of realizing speed-up while suppressing an increase in voltage.

### Solution to Problem

A photomultiplier tube according to the present disclosure is [1] A photomultiplier tube including: a photoelectric surface configured to emit photoelectrons in response to incident light; an electron multiplying unit including a plurality of dynodes configured to emit secondary electrons in response to incidence of the photoelectrons emitted from the photoelectric surface and to multiply the secondary electrons; an acceleration electrode disposed between the photoelectric surface and the electron multiplying unit and configured to accelerate the photoelectrons to be incident to the electron multiplying unit; and a tubular accommodation container accommodating the photoelectric surface, the acceleration electrode, and the electron multiplying unit, in which when viewed from a tube diameter direction intersecting a tube axial direction of the accommodation container, the photoelectric surface, the acceleration electrode, and the electron multiplying unit are disposed so that other members are not interposed between a first end portion of the acceleration electrode on the photoelectric surface side in the tube axial direction and the photoelectric surface, and between a second end portion of the acceleration electrode on the electron multiplying unit side in the tube axial direction and the electron multiplying unit”.

In the photomultiplier tube of [1], the acceleration electrode that accelerates the photoelectrons to be incident to the electron multiplying unit is provided between the photoelectric surface that emits photoelectrons in response to incident light, and the electron multiplying unit that multiplies the secondary electrons in response to the photoelectrons. In addition, when viewed from the tube diameter direction of the accommodation container, the photoelectric surface, the acceleration electrode, and the electron multiplying unit are disposed so that other members such as a focusing electrode are not interposed between the first end portion of the acceleration electrode on the photoelectric surface side in the tube axial direction and the photoelectric surface, and between the second end portion of the acceleration electrode on the electron multiplying unit side in the tube axial direction and the electron multiplying unit. Accordingly, the photoelectric surface, the acceleration electrode, and the electron multiplying unit are disposed relatively close to each other, and thus it is possible to avoid an increase in focal length and to suppress a decrease in electric field intensity of the acceleration electrode. Accordingly, it is possible to realize speed-up while suppressing an increase in voltage.

The photomultiplier tube according to the present disclosure may be [2] “The photomultiplier tube according to [1], in which the acceleration electrode includes a flange portion that extends from the second end portion in the tube diameter direction”. According to the photomultiplier tube according to [2], the flange portion suppresses surplus photoelectrons which deteriorate TTS, such as photoelectrons emitted from a non-effective region instead of an effective region of the photoelectric surface, from being incident to the electron multiplying unit.

The photomultiplier tube according to the present disclosure may be [3] “The photomultiplier tube according to [2], in which the flange portion extends up to an outer side of the electron multiplying unit when viewed from the tube axial direction”. According to the photomultiplier tube according to [3], surplus photoelectrons are more reliably suppressed from being incident to the electron multiplying unit.

The photomultiplier tube according to the present disclosure may be [4] “The photomultiplier tube according to any one of [1] to [3], in which the acceleration electrode includes the first end portion and the second end portion, and includes a tubular portion provided with a through-hole through which the photoelectrons pass, and a length of the tubular portion in the tube axial direction is equal to or more than a radius of the through-hole”. According to the photomultiplier tube according to [4], it is possible to shield surplus photoelectrons while collecting desired photoelectrons emitted from the effective region of the photoelectric surface in the tubular portion.

The photomultiplier tube according to the present disclosure may be [5] “The photomultiplier tube according to any one of [1] to [4], further including: a focusing electrode configured to focus the photoelectrons emitted from the photoelectric surface toward the electron multiplying unit, in which the focusing electrode is provided in a range overlapping the acceleration electrode when viewed from the tube diameter direction”. According to the photomultiplier tube according to [5], it is possible to improve a focusing property of the photoelectrons by finely adjusting an acceleration field of the photoelectrons which is formed by the acceleration electrode.

The photomultiplier tube according to the present disclosure may be [6] “The photomultiplier tube according to [5], in which the focusing electrode extends up to an outer side of the electron multiplying unit when viewed from the tube axial direction”. According to the photomultiplier tube described in [6], surplus photoelectrons are suppressed from being incident to the electron multiplying unit while improving a focusing property of the photoelectrons.

The photomultiplier tube according to the present disclosure may be [7] “The photomultiplier tube according to [3], further including: a focusing electrode configured to focus the photoelectrons emitted from the photoelectric surface toward the electron multiplying unit, in which the focusing electrode is provided in a range overlapping the acceleration electrode when viewed from the tube diameter direction, and extends up to an outer side of the flange portion when viewed from the tube axial direction”. According to the photomultiplier tube according to [7], surplus photoelectrons are reliably suppressed from being incident to the electron multiplying unit while improving a focusing property of the photoelectrons.

The photomultiplier tube according to the present disclosure may be [8] “The photomultiplier tube according to any one of [1] to [7], further including: a light-shielding portion configured to shield a non-effective region on an outer side of an effective region that emits the photoelectrons incident to the acceleration electrode on the photoelectric surface”. According to the photomultiplier tube according to [8], since light is suppressed from being incident to the non-effective region of the photoelectric surface, the surplus photoelectrons are more reliably suppressed from being incident to the electron multiplying unit.

### Advantageous Effects of Invention

According to the present disclosure, it is possible to provide a photomultiplier tube capable of realizing speed-up while suppressing an increase in voltage.

### BRIEF DESCRIPTION OF DRAWINGS

FIG. 1 is a schematic cross-sectional view illustrating a photomultiplier tube according to an embodiment.

FIG. 2 is a graph showing CTTD in one direction of the photomultiplier tube.

FIG. 3 is a graph showing CTTD in another direction of the photomultiplier tube.

FIG. 4 shows TTS of the photomultiplier tube according to this embodiment.

FIG. 5 is a schematic cross-sectional view of a photomultiplier tube according to a first modification example.

FIG. 6 is a graph showing characteristics of the photomultiplier tube according to the first modification example.

FIG. 7 is a schematic cross-sectional view of a photomultiplier tube according to a second modification example.

FIG. 8 is a graph showing characteristics of the photomultiplier tube according to the second modification example.

FIG. 9 is a schematic cross-sectional view of a photomultiplier tube according to a third modification example.

FIG. 10 is a graph showing characteristics of the photomultiplier tube according to the third modification example.

### DESCRIPTION OF EMBODIMENTS

Hereinafter, an embodiment will be described with reference to the accompanying drawings. Note that, in description of the drawings, the same reference numeral will be given to the same or equivalent elements, and redundant description thereof may be omitted.

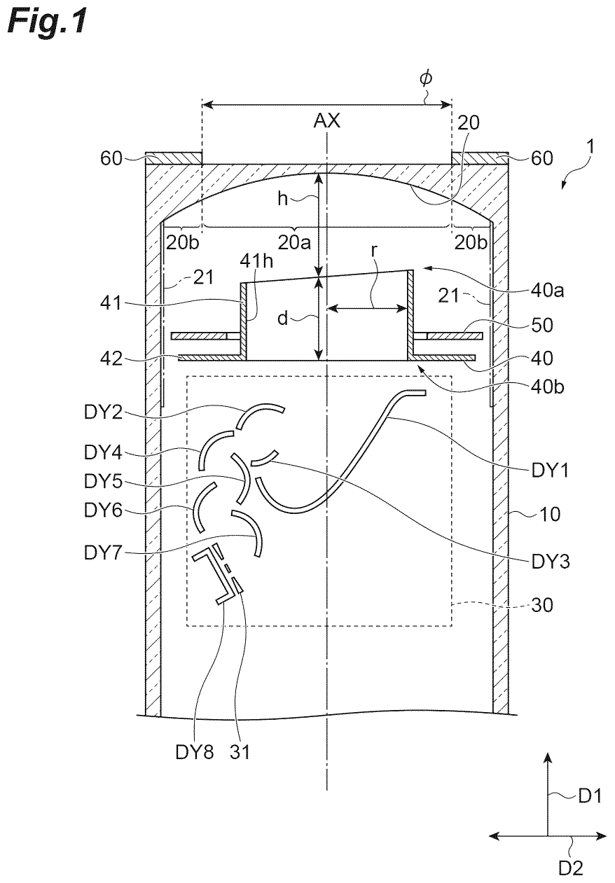

FIG. 1 is a schematic cross-sectional view illustrating a photomultiplier tube according to an embodiment. As illustrated in FIG. 1, a photomultiplier tube 1 includes an accommodation container 10 that is a sealed container of which the inside is evacuated. The accommodation container 10 is formed in a cylindrical tube shape of which both ends are sealed. In the following description, a direction along a tube axis AX of the accommodation container 10 is set as a tube axial direction D1, and a direction that is a diameter direction of the accommodation container 10 and intersects (orthogonal to) the tube axial direction D1 is set as a tube diameter direction D2.

The photomultiplier tube 1 includes a photoelectric surface 20 accommodated in the accommodation container 10, an electron multiplying unit 30, an acceleration electrode 40, and a focusing electrode 50. In addition, the photomultiplier tube 1 includes a light-shielding portion 60 provided on an outer side of the accommodation container 10. The photoelectric surface 20 is formed on an inner side of one end portion of the accommodation container 10 in the tube axial direction D1. The photoelectric surface 20 emits photoelectrons in response to incident light. The photoelectric surface 20 faces the acceleration electrode 40, and has a partially spherical curved surface shape that is convex to a side opposite to the acceleration electrode 40. A voltage is applied to the photoelectric surface 20 via a conductive film (power supply member) 21 provided continuously in a peripheral direction so as to surround a peripheral edge portion of the photoelectric surface 20 on an inner wall surface of the accommodation container 10. The conductive film 21 enables a potential to be applied uniformly over the entirety of the photoelectric surface 20. The conductive film 21 contributes to an improvement of stability of TTS by supplying a stable potential to the photoelectric surface 20.

The photoelectric surface 20 includes an effective region 20a that emits photoelectrons to be incident to the acceleration electrode 40, and a non-effective region 20b on an outer side of the effective region 20a. The effective region 20a is a circular region centering around the tube axis AX when viewed from the tube axial direction D1. The non-effective region 20b is a region that is continuous from the effective region 20a and is an annular region centering around the tube axis AX when viewed from the tube axial direction D1.

The electron multiplying unit 30 is disposed to face the photoelectric surface (cathode) 20 via the acceleration electrode 40. The electron multiplying unit 30 includes a plurality of dynodes which emit secondary electrons in response to incidence of photoelectrons emitted from the photoelectric surface 20, and multiplies the secondary electrons. More specifically, the electron multiplying unit 30 includes a first dynode DY1, a second dynode DY2, a third dynode DY3, a fourth dynode DY4, a fifth dynode DY5, a sixth dynode DY6, a seventh dynode DY7, a reflective dynode DY8, and an anode 31.

The first dynode DY1 to the seventh dynode DY7 sequentially cascade-multiply the secondary electrons emitted in response to photoelectrons reached to the first dynode DY1. A reflective secondary electron emission surface that receives photoelectrons or secondary electrons and newly emits secondary electrons toward an incident direction of the electrons is formed in the first dynode DY1 to the seventh dynode DY7, and the reflective dynode DY8. The anode 31 is configured to extract the secondary electrons multiplied by the first dynode DY1 to the seventh dynode DY7 as signals. The reflective dynode DY8 redirects electrons which have passed through the anode 31 back to the anode 31.

The acceleration electrode 40 is disposed between the photoelectric surface 20 and the electron multiplying unit 30, and accelerates the photoelectrons emitted from the photoelectric surface 20 to be incident to the electron multiplying unit 30. Due to the acceleration electrode 40, a variation of transit time of the photoelectrons from the photoelectric surface 20 to the electron multiplying unit 30, which is caused by a photoelectron emission site of the photoelectric surface 20, is reduced. In addition, the acceleration electrode 40 is disposed away from the photoelectric surface 20 and the inner wall surface (further, the conductive film 21) of the accommodation container 10.

The acceleration electrode 40 includes a first end portion 40a, and a second end portion 40b on a side opposite to the first end portion 40a in the tube axial direction D1. The first end portion 40a is an end portion (end portion facing the photoelectric surface 20) on the photoelectric surface 20 side, and the second end portion 40b is an end portion (end portion facing the electron multiplying unit 30) on the electron multiplying unit 30 side. The photoelectric surface 20, the acceleration electrode 40, and the electron multiplying unit 30 are disposed so that other members are not interposed between the first end portion 40a and the photoelectric surface 20 and between the second end portion 40b and the electron multiplying unit 30 when viewed from the tube diameter direction D2.

Note that, for example, the other members stated here are any members including conductive members such as other electrodes such as a focusing electrode. However, the other members stated here exclude members which do not overlap the photoelectric surface 20, the acceleration electrode 40, and the electron multiplying unit 30 when viewed from the tube axial direction D1 such as a side wall portion of the accommodation container 10, support members for supporting various electrodes such as the acceleration electrode 40 and the electron multiplying unit 30 at the inside of the accommodation container 10, fixing members (regardless of conductive/insulating) for fixing the various electrodes and the support members, a power supply member (for example, the conductive film 21) to the photoelectric surface 20 and the various electrodes, and members (for example, the conductive film 21) provided on the inner wall surface of the accommodation container 10. That is, the absence of other members interposed between the first end portion 40a and the photoelectric surface 20 and between the second end portion 40b and the electron multiplying unit 30 stated here represents that there are no other members which interfere when positioning (moving) of the photoelectric surface 20, the acceleration electrode 40, and the electron multiplying unit 30 along the tube axial direction D1.

On the other hand, the other members stated here include members which have an influence on electric fields formed respectively between the photoelectric surface 20 and the acceleration electrode 40, and between the acceleration electrode 40 and the electron multiplying unit 30. In other words, the other members include members applied with a potential different from that of the photoelectric surface 20 and the acceleration electrode 40 between the photoelectric surface 20 and the acceleration electrode 40, and a potential different from that of the acceleration electrode 40 and the first dynode DY1 between the acceleration electrode 40 and the electron multiplying unit 30. That is, as an example, when assembling the acceleration electrode 40, in a case where a member that is formed from metal and is applied with the same potential as in the acceleration electrode 40 may be disposed between the acceleration electrode 40 and the electron multiplying unit 30, but the member has the same potential as in the acceleration electrode 40 and does not correspond to the member applied with a potential different from that of the acceleration electrode 40 and the first dynode DY1, and is not included in the other members (that is, can be interposed).

Here, the acceleration electrode 40 includes a tubular portion 41 and a flange portion 42. The tubular portion 41 has a cylindrical shape extending along the tube axial direction D1 and includes the first end portion 40a and the second end portion 40b. A through-hole 41h through which photoelectrons pass is provided in the tubular portion 41. The tubular portion 41 and the through-hole 41h have a diameter smaller than the effective region 20a of the photoelectric surface 20 when viewed from the tube axial direction D1, and have a circular shape centering around the tube axis AX. In this example, an end surface of the tubular portion 41 on the second end portion 40b side is approximately parallel to a surface orthogonal to the tube axis AX, but an end surface of the tubular portion 41 on the first end portion 40a side is inclined to the surface orthogonal to the tube axis AX so as to correspond to an inclination of the first dynode DY1 (to be inclined in the same direction). Due to the inclination, it is possible to increase the acceleration of electrons of which a transit distance to the first dynode DY1 is long as compared with the acceleration of electrons of which a transit distance is short, thereby reducing a transit time distance.

The flange portion 42 has an annular plate shape and extends from the second end portion 40b of the tubular portion 41 toward an outer side of the tubular portion 41 along the tube diameter direction D2. The flange portion 42 extends to reach an outer side of the electron multiplying unit 30 when viewed from the tube axial direction D1. That is, an end portion of the flange portion 42 in the tube diameter direction D2 is located on an outer side of the electron multiplying unit 30. According to this, the acceleration electrode 40 covers the entirety of the electron multiplying unit 30 as a whole when viewed from the tube axial direction D1.

The focusing electrode 50 focuses the photoelectrons emitted from the photoelectric surface 20 toward the electron multiplying unit 30. That is, the focusing electrode 50 has a function of adjusting a trajectory of the photoelectrons so that the photoelectrons emitted from the photoelectric surface 20 are focused to the electron multiplying unit 30. The focusing electrode 50 is formed in an annular plate shape having a through-hole 50h, and is disposed in such a manner that the acceleration electrode 40 (tubular portion 41) is inserted into the inside of the through-hole 50h. The focusing electrode 50 and the through-hole 50h have an annular shape centering around the tube axis AX when viewed from the tube axial direction D1.

The focusing electrode 50 is provided in a range overlapping the acceleration electrode 40 when viewed from the tube diameter direction D2. In other words, the focusing electrode 50 is located between the first end portion 40a and the second end portion 40b when viewed from the tube diameter direction D2, and does not protrude from the acceleration electrode 40. On the other hand, the focusing electrode 50 extends to reach an outer side of the electron multiplying unit 30 when viewed from the tube axial direction D1. That is, when viewed from the tube axial direction D1, an outer edge of the focusing electrode 50 is located on an outer side of the electron multiplying unit 30.

In addition, here, when viewed from the tube axial direction D1, the focusing electrode 50 extends to reach a further outer side of the flange portion 42. That is, here, when viewed from the tube axial direction D1, an outer edge of the focusing electrode 50 is located on a further outer side of the outer edge of the flange portion 42. Note that, in the example illustrated in the drawing, the focusing electrode 50 and the flange portion 42 of the acceleration electrode 40 are approximately parallel to each other.

The magnitudes of voltages which are respectively applied to the acceleration electrode 40 and the focusing electrode 50 are different from each other. That is, a larger voltage is applied to the acceleration electrode 40 as compared with the focusing electrode 50. As an example, a voltage larger than a voltage applied to the first dynode DY1 (for example, a voltage equal to a voltage applied to the sixth dynode DY6) is applied to the acceleration electrode 40. On the other hand, as an example, a voltage equal to or less than the voltage applied to the first dynode DY1 is applied to the focusing electrode 50.

The light-shielding portion 60 is provided on an outer side of one end portion of the accommodation container 10 in the tube axial direction D1. The light-shielding portion 60 is formed in an annular shape centering around the tube axis AX when viewed from the tube axial direction D1, and is provided on an outer surface of the accommodation container 10 so as to cover the non-effective region 20b of the photoelectric surface 20. The light-shielding portion 60 shields the non-effective region 20b from light so that photoelectrons are not emitted from the non-effective region 20b.

Here, description will be given of sizes of the photoelectric surface 20 and the acceleration electrode 40, and a positional relationship thereof. The effective region 20a of the photoelectric surface 20 has a diameter when viewed from the tube axial direction D1. In the photoelectric surface 20, the non-effective region 20b is shielded from light by the light-shielding portion 60, the diameter φ of the effective region 20a is narrowed (made smaller than the overall diameter), and as a result, the focal length of the photoelectrons is shortened.

On the other hand, the tubular portion 41 (through-hole 41h) of the acceleration electrode 40 has a radius r. In addition, the tubular portion 41 has a length d in the tube axial direction D1. The length d is also a length between the first end portion 40a and the second end portion 40b in the tubular portion 41. As described above, in the tubular portion 41, the end surface on the first end portion 40a side is inclined with respect to a surface orthogonal to the tube axis AX, and the end surface on the second end portion 40b side is approximately parallel to the surface orthogonal to the tube axis AX.

Accordingly, the length d varies depending on a position in the peripheral direction of the tubular portion 41 (varies in correspondence with the tube diameter direction D2 in the cross-section shown in the drawing). Here, the length d is set as a value on the tube axis AX. The length d is equal to or more than the radius r. In addition, the photomultiplier tube 1 has a distance h between the first end portion 40a of the tubular portion 41 and the photoelectric surface 20 (effective region 20a) in the tube axis AX. Making the length d larger than a certain value (the radius r) contributes to bringing the first end portion 40a of the tubular portion 41 close to the photoelectric surface 20 by the distance h.

According to this, in the photomultiplier tube 1, since the first end portion 40a of the tubular portion 41 of the acceleration electrode 40 is brought to the vicinity of the effective region 20a, which has a narrowed diameter § and a short focal length, approximately at the distance h, it is possible to form a sufficient acceleration field of the photoelectrons without using a high voltage, for example, 2000 V (at a relatively low voltage) and it is possible to accelerate the photoelectrons while guiding the photoelectrons to the through-hole 50h having the radius r from the effective region 20a. In this manner, in the photomultiplier tube 1, the distance h, the diameter φ, and the radius r can be set in association with each other. As an example, the distance h can be set to a range of approximately 0.6 times or more to 0.8 times or less of the diameter φ. In addition, the radius r can be set to a range of approximately 0.2 times or more to 0.3 times or less of the diameter φ. When setting the distance h, the diameter φ, and the radius r, the length d can also be considered. In this case, for example, the length d can be set to a range of approximately 0.3 times or more to 0.5 times or less of the diameter. In addition, a ratio between the length d and the radius r (length d/radius r) can be set to a range of approximately 1.0 times or more to 1.6 times or less.

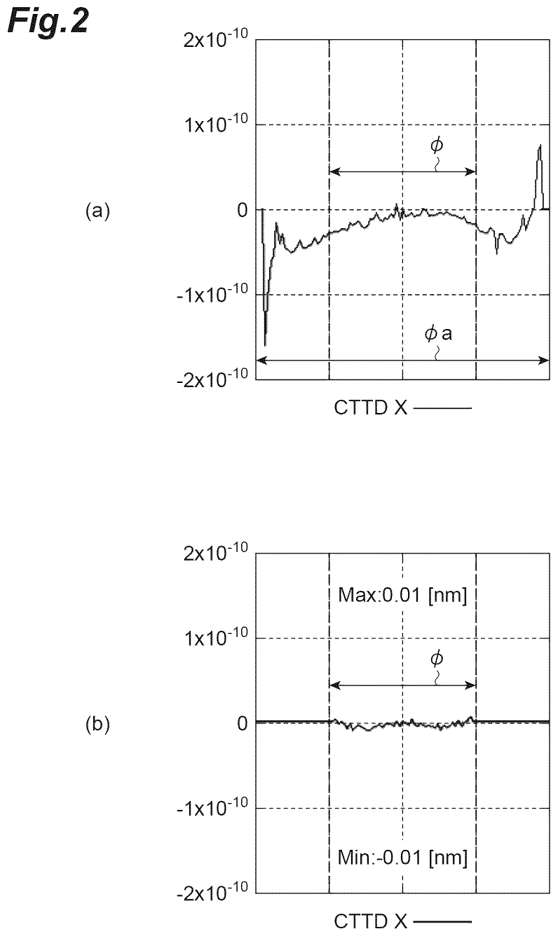

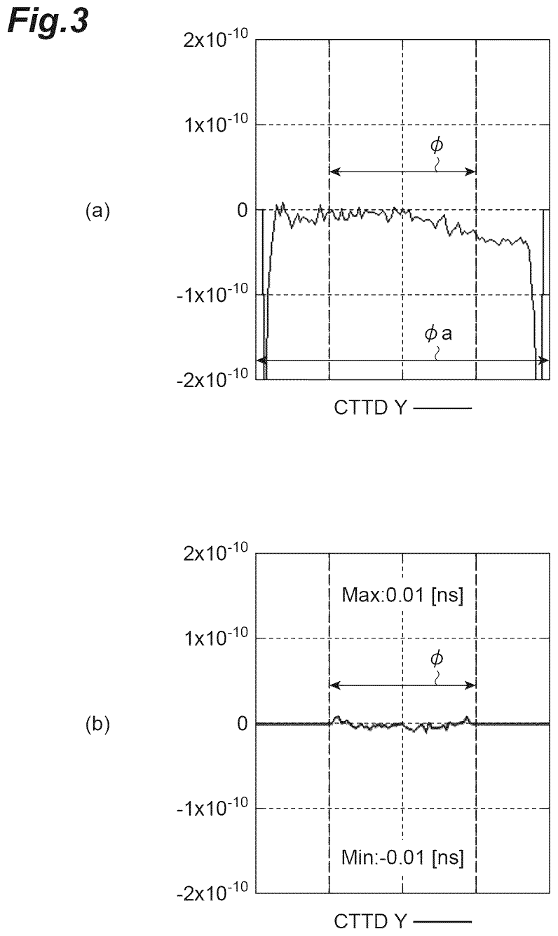

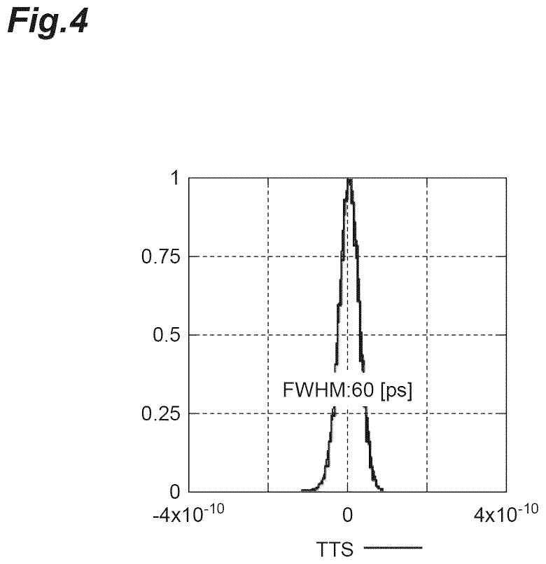

Next, an operation and an effect of the photomultiplier tube 1 will be described. (a) in FIG. 2 and (a) in FIG. 3 show a cathode transit time difference (CTTD) that is a transit time difference of photoelectrons in a photomultiplier tube according to a comparative example, and (b) in FIG. 2 and (b) in FIG. 3 show a CTTD of the photomultiplier tube 1 according to this embodiment. In FIG. 2, a CTTD relating to an X-direction that is one direction of the tube diameter direction D, and in FIG. 3, a CTTD relating to a Y-direction (direction orthogonal to the X-direction) that is the other direction of the tube diameter direction. FIG. 4 shows a TTS of the photomultiplier tube 1 according to this embodiment.

In the comparative example, the light-shielding portion 60 is not provided, and the effective region of the photoelectric surface is not narrowed (the focal length is not shortened). Note that, pa represents a diameter of the photoelectric surface of the comparative example. In addition, in the comparative example, the focal length of the effective region is not shortened, and thus a distance between the photoelectric surface and the acceleration electrode is large, and the focusing electrode is interposed therebetween. The other configurations of the comparative example are the same as that of the photomultiplier tube 1 according to this embodiment.

As illustrated in FIGS. 2 and 3, in the photomultiplier tube 1 according to this embodiment, it can be seen that the CTTD is flat in both the X-direction and the Y-direction (the transit time difference is reduced) as compared with the photomultiplier tube according to the comparative example. In addition, as illustrated in FIG. 4, according to the photomultiplier tube 1 according to this embodiment, a TTS of 60 ps is achieved under a voltage of 1500 V. Note that, according to the finding of the present inventors, even in the photomultiplier tube according to the comparative example, a TTS of 90 ps less than 100 ps can be realized, but at this time, a high voltage of 2000 V is required.

As described above, in the photomultiplier tube 1, the acceleration electrode 40 that accelerates photoelectrons to be incident to the electron multiplying unit 30 is provided between the photoelectric surface 20 that emits photoelectrons in response to incident light and the electron multiplying unit 30 that multiplies secondary electrons corresponding to the photoelectrons. In addition, when viewed from the tube diameter direction D2 of the accommodation container 10, the photoelectric surface 20, the acceleration electrode 40, and the electron multiplying unit 30 are disposed so that other members such as other electrodes such as the focusing electrode 50 are not interposed between the first end portion 40a of the acceleration electrode 40 on the photoelectric surface 20 side in the tube axial direction D1 and the photoelectric surface 20, and between the second end portion 40b of the acceleration electrode 40 on the electron multiplying unit 30 side in the tube axial direction D1 and the electron multiplying unit 30. Accordingly, since the photoelectric surface 20, the acceleration electrode 40, and the electron multiplying unit 30 are disposed relatively close to each other, it is possible to avoid an increase in focal length and to suppress a decrease in electric field intensity of the acceleration electrode 40. In addition, it is possible to shorten the transit distance of the photoelectrons from the photoelectric surface 20 to the electron multiplying unit 30. Accordingly, it is possible to realize speed-up while suppressing an increase in voltage.

In addition, in the photomultiplier tube 1, the acceleration electrode 40 includes the flange portion 42 that extends from the second end portion 40b in the tube diameter direction D2. Accordingly, the flange portion 42 suppresses surplus photoelectrons which deteriorate the TTS, such as photoelectrons emitted from the non-effective region 20b instead of the effective region 20a of the photoelectric surface 20, from being incident to the electron multiplying unit 30.

In addition, in the photomultiplier tube 1, the flange portion 42 extends up to an outer side of the electron multiplying unit 30 when viewed from the tube axial direction D1. Accordingly, surplus photoelectrons are more reliably suppressed from being incident to the electron multiplying unit 30.

In addition, in the photomultiplier tube 1, the acceleration electrode 40 includes the first end portion 40a and the second end portion 40b, and includes the tubular portion 41 provided with the through-hole 41h through which the photoelectrons pass, and a length d of the tubular portion 41 in the tube axial direction D1 is equal to or more than a radius r of the through-hole 41h. Accordingly, the tubular portion 41 shields photoelectrons emitted from the non-effective region 20b not to be incident to the electron multiplying unit 30 while collecting desired photoelectrons emitted from the effective region 20a of the photoelectric surface 20, thereby shielding surplus photoelectrons.

In addition, the photomultiplier tube 1 further includes the focusing electrode 50 configured to focus the photoelectrons emitted from the photoelectric surface 20 toward the electron multiplying unit 30. In addition, the focusing electrode 50 is provided in a range overlapping the acceleration electrode 40 when viewed from the tube diameter direction D2. Accordingly, it is possible to improve a focusing property of the photoelectrons by finely adjusting an acceleration field of the photoelectrons which is formed by the acceleration electrode 40.

This point will be described in more detail. In the photomultiplier tube 1 the acceleration electrode 40 includes the tubular portion 41 and the flange portion 42. In this manner, when adding the flange portion 42 that suppresses surplus photoelectrons from being incident to the electron multiplying unit 30 to the tubular portion 41, a shape of an equipotential surface varies due to the flange portion 42, and an electron lens formed between the photoelectric surface 20 and the acceleration electrode 40 widens, and thus there is a concern that the focusing property of the photoelectrons deteriorates (the effective region 20a is narrowed). The reason why the focusing property of the photoelectrons deteriorates in correspondence with the widening of the electron lens is because electrons move with constant acceleration in an electric field in a direction orthogonal to the equipotential surface. In contrast, for example, when the focusing electrode 50 is provided to cover the flange portion 42 of the acceleration electrode 40, it is possible to finely adjust an acceleration field so that the shape of the electron lens is adjusted (suppressed from widening).

In addition, it is important that the focusing electrode 50 does not interfere with the electric field (acceleration field) formed by the acceleration electrode 40, it is not preferable that the focusing electrode 50 is disposed to further protrude to the photoelectric surface 20 side (that is, interposed between the photoelectric surface 20 and the acceleration electrode 40) as compared with the acceleration electrode 40. That is, in order to improve the focusing property of electrons without interfering with movement of the acceleration electrode 40, the position of the focusing electrode 50 can be set to a position overlapping the acceleration electrode 40 when viewed from the tube diameter direction D2. In addition, when employing a flat plate shape as the focusing electrode 50, there is an advantage that fine adjustment of the acceleration field becomes easy in accordance with an opening diameter or an outer diameter of the focusing electrode 50, and a position thereof in the tube axial direction D1.

In addition, in the photomultiplier tube 1, the focusing electrode 50 extends up to an outer side of the electron multiplying unit 30 when viewed from the tube axial direction D1. Accordingly, surplus photoelectrons are suppressed from being incident to the electron multiplying unit 30 while improving the focusing property of the photoelectrons.

In addition, in the photomultiplier tube 1, the focusing electrode 50 is provided in a range overlapping the acceleration electrode 40 when viewed from the tube diameter direction D2 and extends up to an outer side of the flange portion 42 when viewed from the tube axial direction D1. Accordingly, as described above, surplus photoelectrons are reliably suppressed from being incident to the electron multiplying unit while improving the focusing property of the photoelectrons.

In addition, in the photomultiplier tube 1, since acceleration electrode 40 and the focusing electrode 50 are applied with potentials different from each other, the acceleration electrode 40 and the focusing electrode 50 are disposed away from each other with a predetermined gap. Accordingly, there is a concern that the surplus photoelectrons emitted from the photoelectric surface 20 may be incident to the electron multiplying unit 30 through the gap. However, when the flange portion 42 of the acceleration electrode 40 is disposed to overlap the gap when viewed from the tube axial direction D1, the surplus photoelectrons are suppressed from being incident to the electron multiplying unit 30. According to this, the surplus photoelectrons are more reliably suppressed from being incident to the electron multiplying unit 30 while improving the focusing property of the photoelectrons.

Furthermore, the photomultiplier tube 1 further includes the light-shielding portion 60 configured to shield the non-effective region 20b on an outer side of the effective region 20a that emits the photoelectrons incident to the acceleration electrode 40 on the photoelectric surface 20. Therefore, since light is suppressed from being incident to the non-effective region 20b of the photoelectric surface 20, the surplus photoelectrons are more reliably suppressed from being incident to the electron multiplying unit 30.

The above-described embodiment illustrates an aspect of the present disclosure. Accordingly, the photomultiplier tube 1 according to the embodiment can be arbitrarily modified. Next, description will be given to modification examples of the photomultiplier tube.

### First Modification Example

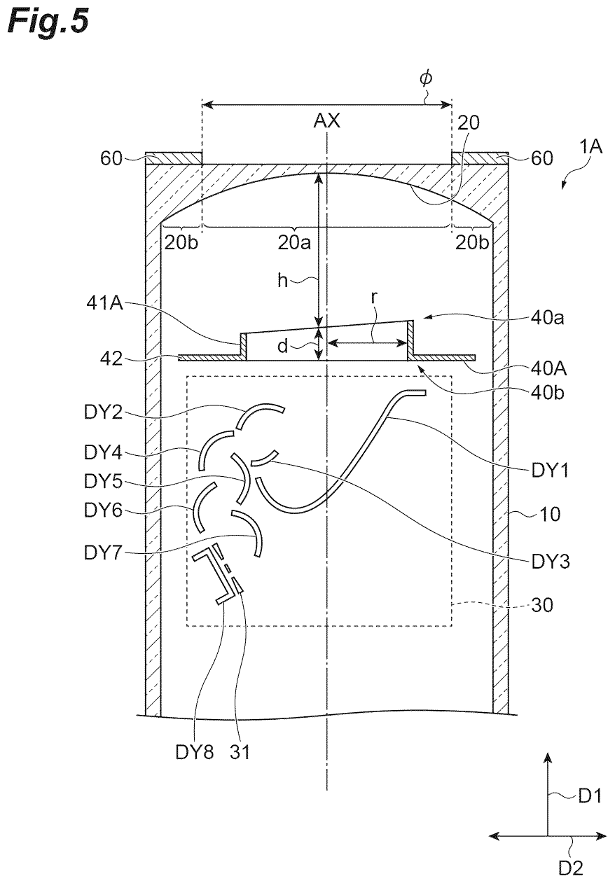

FIG. 5 is a schematic cross-sectional view of a photomultiplier tube according to a first modification example. As illustrated in FIG. 5, a photomultiplier tube 1A according to the first modification example is the same as the photomultiplier tube 1 according to the embodiment except that the focusing electrode 50 is not provided and an acceleration electrode 40A is used instead of the acceleration electrode 40. The acceleration electrode 40A includes a tubular portion 41A instead of the tubular portion 41. The length d of the tubular portion 41A is set to be smaller as compared with the tubular portion 41. In this case, when a position of a second end portion 40b of the acceleration electrode 40A in the tube axial direction D1 conforms to the case of the acceleration electrode 40, the distance h increases by an amount corresponding to a reduction of the length d of the tubular portion 41A.

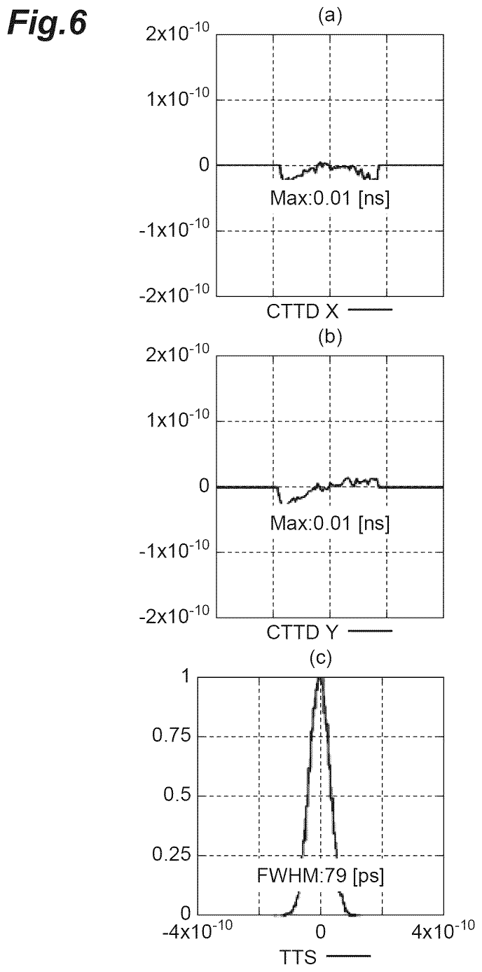

FIG. 6 is a graph showing characteristics of the photomultiplier tube according to the first modification example. (a) to (c) in FIG. 6 sequentially show a CTTD in the X-direction, and a CTTD and TTS in the Y-direction. As illustrated in FIG. 6, according to the photomultiplier tube 1A, flatness of the CTTD is somewhat inferior to that of the photomultiplier tube 1, but a TTS of 79 ps is achieved under a voltage of 1500 V, and sufficient speed-up is achieved. That is, according to the photomultiplier tube 1A, the same effect as in the photomultiplier tube 1 according to the embodiment is exhibited.

### Second Modification Example

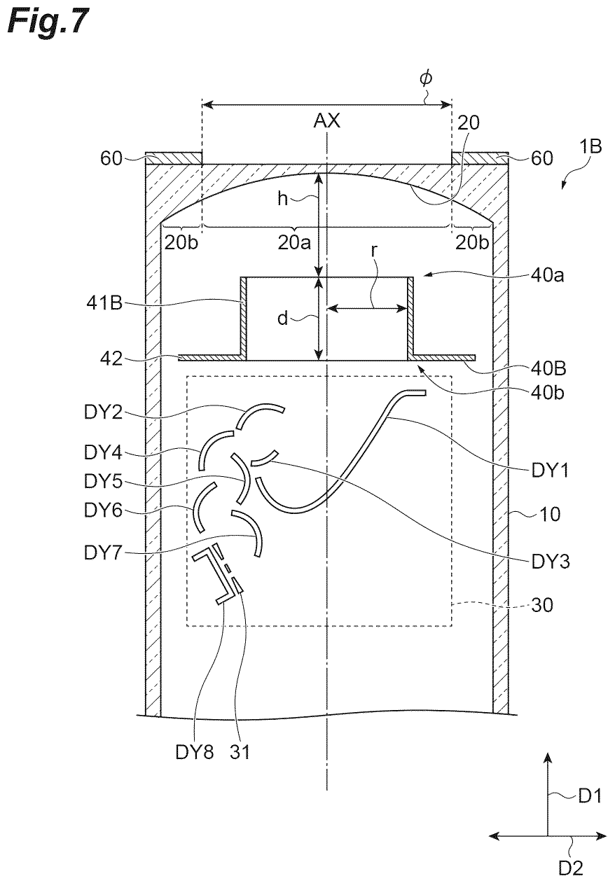

FIG. 7 is a schematic cross-sectional view of a photomultiplier tube according to a second modification example. As illustrated in FIG. 7, a photomultiplier tube 1B is the same as the photomultiplier tube 1 according to the embodiment except that the focusing electrode 50 is not provided, and an acceleration electrode 40B is provided instead of the acceleration electrode 40. The acceleration electrode 40B includes a tubular portion 41B instead of the tubular portion 41. The tubular portion 41B is different from the tubular portion 41 in that both the end surface on the first end portion 40a side and the end surface on the second end portion 40b side are approximately parallel to a surface orthogonal to the tube axis AX. Accordingly, in the tubular portion 41B, the length d (further, the distance h) is constant regardless of a position in the peripheral direction of the tubular portion 41B (in the cross-section shown in the drawing, regardless of a position in the tube diameter direction D2).

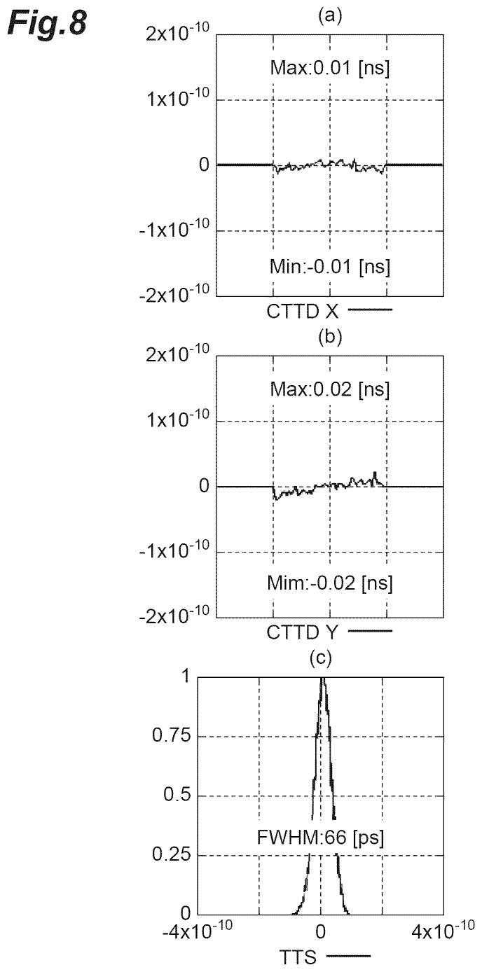

FIG. 8 is a graph showing characteristics of the photomultiplier tube according to the second modification example. (a) to (c) in FIG. 8 sequentially show a CTTD in the X-direction, and a CTTD and TTS in the Y-direction. As illustrated in FIG. 8, according to the photomultiplier tube 1B, flatness of the CTTD is somewhat inferior to that of the photomultiplier tube 1, but a TTS of 66 ps is achieved under a voltage of 1500 V, and sufficient speed-up is achieved. That is, according to the photomultiplier tube 1B, the same effect as in the photomultiplier tube 1 according to the embodiment is also exhibited.

### Third Modification Example

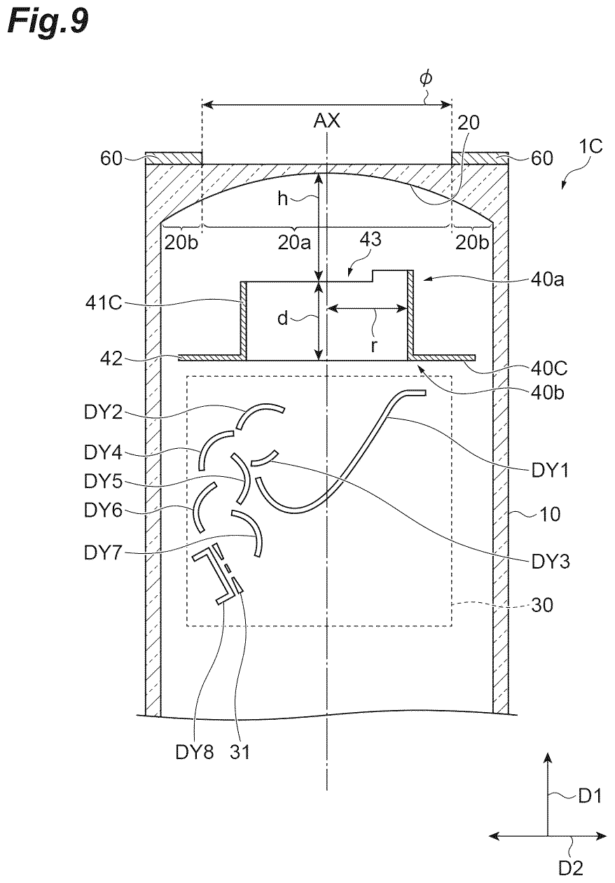

FIG. 9 is a schematic cross-sectional view of the photomultiplier tube according to a third modification example. As illustrated in FIG. 9, a photomultiplier tube 1C according to the third modification example is the same as the photomultiplier tube 1 according to the embodiment except that the focusing electrode 50 is not provided, and an acceleration electrode 40C is provided instead of the acceleration electrode 40. The acceleration electrode 40C includes a tubular portion 41C instead of the tubular portion 41. The tubular portion 41C is different from the tubular portion 41 in that a recessed portion 43 is formed in the first end portion 40a. More specifically, in the tubular portion 41C, since the recessed portion 43 is provided, when viewed from the tube diameter direction D2, a short part having a constant length of length d and a long part having a length longer than length d are formed.

In the tubular portion 41B, in both the short part and the long part, both the end surface on the first end portion 40a side and the end surface on the second end portion 40b side are approximately parallel to the surface orthogonal to the tube axis AX. A position of the long part in the tube diameter direction D2 is set to a position corresponding to an inclination of the first dynode DY1. That is, the long part is disposed so that the tubular portion 41C protrudes to the photoelectric surface 20 side on a portion of the first dynode DY1 which is closer to the photoelectric surface 20. When the protruding portion (recessed portion 43) is provided in this manner, it is possible to increase acceleration of electrons with a long transit distance up to the first dynode DY1 as compared with acceleration of electrons with a short transit distance, and it is possible to reduce a transit time difference (in a more pinpointed manner as compared with the case of forming an inclination in the first end portion 40a).

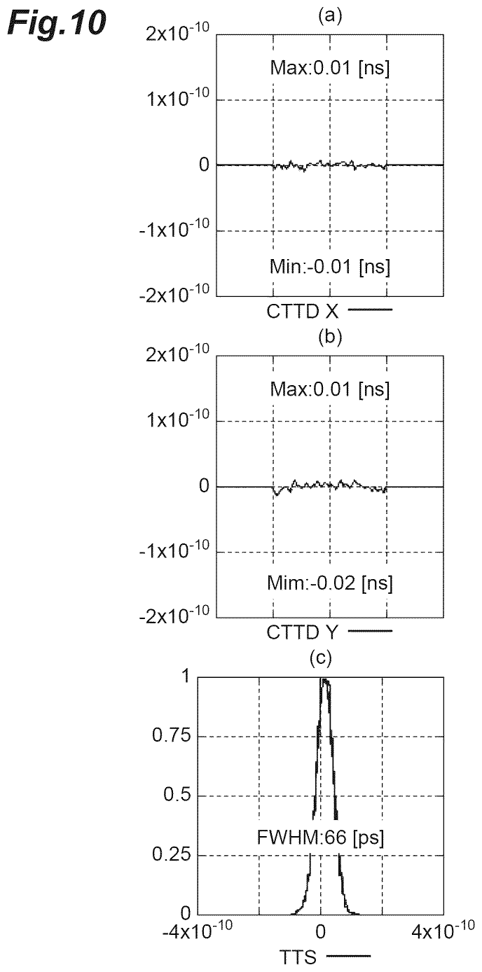

FIG. 10 is a graph showing characteristics of the photomultiplier tube according to the third modification example. (a) to (c) in FIG. 10 sequentially show a CTTD in the X-direction, and a CTTD and TTS in the Y-direction. As illustrated in FIG. 10, according to the photomultiplier tube 1C, flatness of the CTTD is somewhat inferior to that of the photomultiplier tube 1, but a TTS of 66 ps is achieved under a voltage of 1500 V, and sufficient speed-up is achieved. That is, according to the photomultiplier tube 1C, the same effect as in the photomultiplier tube 1 according to the embodiment is also exhibited.

### Other Modification Examples

The above-described photomultiplier tubes 1 to 1C can be further arbitrarily modified. For example, in the photomultiplier tube 1, the focusing electrode 50 may be omitted, and the focusing electrode 50 may be added in the photomultiplier tubes 1A to 1C. However, in the latter case, the focusing electrode 50 is provided in a range overlapping the acceleration electrode 40 when viewed from the tube diameter direction D2. In addition, in a case of providing the focusing electrode 50, the focusing electrode 50 is not limited to extending up to the outer side of the flange portion 42 or the electron multiplying unit 30, and may terminate on an inner side of the flange portion 42 or the electron multiplying unit 30.

In addition, the shape of the focusing electrode 50 is not limited to the flat plate shape, and the focusing electrode 50 may be formed in a tubular shape or in a truncated cone plate shape as a whole by providing an inclined portion in an outer edge portion of a flat plate portion, or may be provided with a protruding portion that extends along the tube axial direction D1 in the outer edge portion of the flat plate portion. In this case, the inclined portion and the protruding portion may be provided to protrude to the electron multiplying unit 30 side with respect to the flat plate portion, or may be provided to protrude to the photoelectric surface 20 side.

The recessed portion 43 in the photomultiplier tube 1C may be provided in the other photomultiplier tubes 1 to 1B. In addition, in the photomultiplier tubes 1 to 1C, the flange portion 42 may be omitted, or the flange portion 42 may be shorted to terminate on an inner side of the electron multiplying unit 30. In addition, the light-shielding portion 60 may be omitted. Even in this case, it is possible to realize a configuration in which photoelectrons from the non-effective region 20b are not incident to the acceleration electrode 40 (through-hole 40h) by adjusting the distance h and the radius r. Note that, in a case of omitting the light-shielding portion 60, the photoelectric surface 20 may be formed only in the effective region 20a (so that the effective region 20a is the only region).

### REFERENCE SIGNS LIST

1, 1A, 1B, 1C: photomultiplier tube, 10: accommodation container, 20: photoelectric surface, 20a: effective region, 20b: non-effective region, 30: electron multiplying unit, 40, 40A, 40B, 40C: acceleration electrode, 40a: first end portion, 40b: second end portion, 41, 41A, 41B, 41C: tubular portion, 41h: through-hole, 42: flange portion, 50: focusing electrode, 60: light-shielding portion, d: length, r: radius, D1: tube axial direction, D2: tube diameter direction.

1. A photomultiplier tube, comprising:
a photoelectric surface configured to emit photoelectrons in response to incident light;
an electron multiplying unit including a plurality of dynodes configured to emit secondary electrons in response to incidence of the photoelectrons emitted from the photoelectric surface and to multiply the secondary electrons;
an acceleration electrode disposed between the photoelectric surface and the electron multiplying unit and configured to accelerate the photoelectrons to be incident to the electron multiplying unit; and
a tubular accommodation container accommodating the photoelectric surface, the acceleration electrode, and the electron multiplying unit,
wherein when viewed from a tube diameter direction intersecting a tube axial direction of the accommodation container, the photoelectric surface, the acceleration electrode, and the electron multiplying unit are disposed so that other members are not interposed between a first end portion of the acceleration electrode on the photoelectric surface side in the tube axial direction and the photoelectric surface, and between a second end portion of the acceleration electrode on the electron multiplying unit side in the tube axial direction and the electron multiplying unit.

2. The photomultiplier tube according to claim 1,
wherein the acceleration electrode includes a flange portion that extends from the second end portion in the tube diameter direction.

3. The photomultiplier tube according to claim 2,
wherein the flange portion extends up to an outer side of the electron multiplying unit when viewed from the tube axial direction.

4. The photomultiplier tube according to claim 1,
wherein the acceleration electrode includes the first end portion and the second end portion, and includes a tubular portion provided with a through-hole through which the photoelectrons pass, and
a length of the tubular portion in the tube axial direction is equal to or more than a radius of the through-hole.

5. The photomultiplier tube according to claim 1, further comprising:
a focusing electrode configured to focus the photoelectrons emitted from the photoelectric surface toward the electron multiplying unit,
wherein the focusing electrode is provided in a range overlapping the acceleration electrode when viewed from the tube diameter direction.

6. The photomultiplier tube according to claim 5,
wherein the focusing electrode extends up to an outer side of the electron multiplying unit when viewed from the tube axial direction.

7. The photomultiplier tube according to claim 3, further comprising:
a focusing electrode configured to focus the photoelectrons emitted from the photoelectric surface toward the electron multiplying unit,
wherein the focusing electrode is provided in a range overlapping the acceleration electrode when viewed from the tube diameter direction, and extends up to an outer side of the flange portion when viewed from the tube axial direction.

8. The photomultiplier tube according to claim 1, further comprising:
a light-shielding portion configured to shield a non-effective region on an outer side of an effective region that emits the photoelectrons incident to the acceleration electrode on the photoelectric surface.
